(19) United States
(12) Patent Application Publication
(10) Pub. No.: US 2026/0125287 A1
(43) Pub. Date: May 7, 2026

(54) SYSTEM AND METHOD FOR ION REMOVAL FROM WATER USING MAGNETIC PARTICLES

(71) Applicant: Montana Technological University, Butte, MT (US)

(72) Inventors: Jerome Downey, Butte, MT (US); David Hutchins, Butte, MT (US); Teagan Leitzke, Butte, MT (US)

(21) Appl. No.: 19/382,194

(22) Filed: Nov. 6, 2025

Related U.S. Application Data
(60) Provisional application No. 63/717,353, filed on Nov. 7, 2024.

(51) Int. Cl. C02F 1/28; C02F 1/48; C02F 101/10

(52) U.S. Cl. CPC C02F 1/281; C02F 1/488; C02F 2101/10; C02F 2303/16

(57) ABSTRACT

The disclosed method and system use a reactor system which can remove ions from an aqueous fluid such as wastewater using magnetic particles such as those comprising magnetite.

### CROSS-REFERENCE TO RELATED APPLICATIONS

This application claims priority to U.S. Provisional Application No. 63/717,353, filed Nov. 7, 2024, which is incorporated into this application by reference.

### STATEMENT OF GOVERNMENT SUPPORT

Aspects of this disclosure were made with government support, including Department of Energy Grant No. DE-FG02-04ER86186 and U.S. Army Combat Capabilities Development Command Grant No. W911NF-22-2-0015. The government has certain rights in the invention.

### BACKGROUND

Natural waters and anthropogenic wastewaters can contain trace levels of toxic materials, such as metals and nutrients. Metals exposure can occur due to natural phenomenon, such as erosion or volcanic eruptions, or anthropogenic activities, including industrial operations, electroplating, and mining. Nutrient contamination can be caused by anthropogenic sources, including food product processing and agricultural or storm water runoff, and geogenic sources. Humans, aquatic life, plant life, and the environment can be detrimentally affected by exposure to toxic materials, including cancer, organ damage, and eutrophication. Contaminated waters pose crucial threats to human health, aquatic and plant life, and the environment, leading to the need for an efficient and effective method for ion removal.

Trace levels of high-value materials, including critical materials (CMs) and rare earth elements (REEs), can also be present in natural waters, hydrometallurgical leachates, and anthropogenic wastewaters. The growing demand for and importance of CMs and REEs has led to increased interest in extraction not only from traditional sources, but unconventional ones, including mine tailings, municipal sludges, electronic waste, and acid mine drainage. Challenges associated with high-value material recovery include low concentrations and recoveries, high energy requirements, excessive costs of operation and disposal of waste, and pollution. Sustainable, effective, and economic methods for high-value material recovery from traditional and unconventional sources are needed to minimize environmental impacts and maintain the supply chain of these materials.

Researchers are utilizing conventional technologies and developing innovative technologies to address and facilitate ion removal and material recovery. These technologies include coagulation, sedimentation, high gradient magnetic separation, membrane bioreactor technologies, electro-adsorption, and reverse osmosis. Research involving new ion removal technologies have limited knowledge of large-scale use and continuous operation, mostly performing on the laboratory-scale. Conventional batch ion exchange systems typically utilize discontinuous batch mode operation, involve complex and expensive processes, are susceptible to fouling, and may have limitations in their ion adsorption capabilities. The current disclosure addresses these challenges by utilizing a reactor system that incorporates magnetic submicron-composite particles capable of effectively bonding with a wide range of ions in wastewater and is capable of continuous mode operation in some embodiments.

### SUMMARY

In one embodiment, the disclosed method of processing an aqueous fluid comprising ions comprises contacting the aqueous fluid with magnetic particles, thereby adsorbing ions to the magnetic particles; after the contacting step, capturing the magnetic particles from the aqueous fluid with an energized magnet (e.g., an electromagnet); diverting the aqueous fluid away from the captured magnetic particles in some embodiments, thereby removing ions from the fluid; and de-energizing the magnet, thereby releasing the magnetic particles. In a further embodiment, ions can be desorbed from the magnetic particles and further processed. In another embodiment, the magnetic particles can be reconditioned and re-used, e.g., in a continuous reactor process in which magnetic particles can be re-introduced into ion-containing aqueous fluid entering the process.

The disclosed reactor system can be used with the processing method. In one embodiment, the reactor system comprises: a fluid inlet for introducing ion-containing aqueous fluid; at least one ion extraction zone configured to allow contact of the aqueous fluid with magnetic particles, to thereby adsorb ions to the magnetic particles; at least one magnetic collection zone configured to capture the magnetic particles having adsorbed ions using a magnetic field energized by a magnet; a system to divert the magnetic particles from the aqueous fluid, and thereby remove ions from the aqueous fluid; and at least one magnetic particle scavenging zone and system configured to capture any breakthrough magnetic particles; optionally, a reconditioning zone configured to recondition the magnetic particles and re-introduce them into the aqueous fluid; and a fluid outlet for directing processed aqueous fluid out of the reactor system. In various embodiments, the reactor system can include one or more zones present in a continuous flow reactor, or present in a batch, semi-batch, pipeline, or plug flow reactor vessel, including any combination of these types of systems and reactor vessels.

### BRIEF DESCRIPTION OF THE DRAWINGS

The foregoing summary, as well as the following description of the disclosure, is better understood when read in conjunction with the appended drawings. For the purpose of illustrating the disclosure, the drawings illustrate some, but not all, alternative embodiments. This disclosure is not limited to the precise arrangements and instrumentalities shown. The following figures, which are incorporated into and constitute part of the specification, assist in explaining the principles of the disclosure.

FIG. 1 is a schematic of an exemplary reactor system for processing wastewater according to the described method.

FIG. 2 is a plot of copper removal efficiency and loading for cycling experiments discussed in the Examples below.

FIG. 3 is an SEM image of Fe₃O₄ particles at 415-times magnification.

FIG. 4 is a schematic of a continuous flow material recovery experimental setup for flow-through operation as described in the Examples below.

FIG. 5A is an interaction plot for the magnetite breakthrough model discussed in the Examples below.

FIG. 5B is an interaction plot for the magnetite loss model discussed in the Examples below.

FIG. 6 is a plot showing averaged cumulative copper removal efficiencies for duplicate 10 h continuous flow experiments. Insert: Average pH for duplicated 10 h continuous flow experiments. The lines connecting the data points are for visual purposes only.

FIG. 7A shows an exemplary disclosed continuous flow material recovery (CFMR) in a single-line series configuration. The CFMR system 10 includes a plurality of tanks 20 in series with a plurality of magnetic collection modules 30, pumps 40, and piping 50. A more detailed view of a magnetic collection module 30 is shown in FIG. 7B.

FIG. 7B shows an exemplary embodiment of a magnetic collection module 30, shown in the in-series configuration of the CRMR system of FIG. 7A. The magnetic collection module 30 includes an entry point 320 where water (e.g., wastewater or slurry) flows into the module 30. Flow can be controlled with the valve 340 before it enters the magnetic portion 360 of the module 30, which removes ions from the water and provides a concentrated slurry 380 (e.g., magnetite slurry) for further processing. Ion removal can be aided with a strip solution which can be introduced into the module at the port 410. The module 30 may also include a sample port 390 before the flow goes to the next module past valve 400. A bypass line segment 405 may include one or more valves 420 for controlling flow through the bypass line.

### DETAILED DESCRIPTION

The disclosed continuous flow material recovery (CFMR) system provides a simple and efficient method for water treatment, compared to other technologies, utilizing magnetic particles (e.g., magnetite (Fe₃O₄) as one exemplary adsorbent) and provides for large-scale, continuous or batch operation for ion removal processes. The system can be modified for differing scales of operation, with the option of using it on-site to avoid transport of ion-containing waters to a treatment facility. Continuous operation of the system is also advantageous, especially for processing large volumes of water at industrial scales.

The method described above is particularly suitable for wastewater and waters containing high-value materials such as rare earth elements (REEs). In some embodiments, the aqueous fluid can be waters that comprise a wide range of cations and anions, including not limited to one or more of the following ions: Cu²⁺, Pb²⁺, PO₄³⁻, SeO₃²⁻, Se⁴⁺, Gd³⁺, or La³⁺. Other ions that can be removed include alkali metal cations, such as sodium (Na⁺), potassium (K⁺), lithium (Li⁺), cesium (Cs⁺), rubidium (Rb⁺); alkali earth metal cations such as calcium (Ca²⁺), magnesium (Mg²⁺), barium (Ba²⁺), strontium (Sr²⁺); transition metal ions such as iron (II) and iron (III) (Fe²⁺, Fe³⁺), manganese (II) (Mn²⁺), zinc (Zn²⁺), copper (I) and copper (II) (Cu⁺, Cu²⁺), nickel (Ni²⁺), chromium (III) (Cr³⁺), cobalt (II) (Co²⁺), cadmium (Cd²⁺), lead (II) (Pb²⁺), mercury (I) and mercury (II) (Hg⁺, Hg²⁺); other metal ions such as aluminum (Al³⁺), tin (II) and tin (IV) (Sn²⁺, Sn⁴⁺), bismuth (Bi³⁺), silver (Ag⁺), scandium (Sc³⁺); non-metals and metalloids such as ammonium (NH₄⁺), hydronium (H₃O⁺) (which is used for pH adjustment and acidity), hydrogen (H⁺) (which is often removed or managed in acid-base applications), germanium (Ge⁴⁺); halides such as chloride (Cl⁻), bromide (Br⁻), iodide (I⁻), fluoride (F⁻); oxyanions such as a sulfate (SO₄²⁻), nitrate (NO₃⁻), nitrite (NO₂⁻), phosphate (PO₄³⁻), carbonate (CO₃²⁻), bicarbonate (HCO₃⁻), chromate (CrO₄²⁻), dichromate (Cr₂O₇²⁻), permanganate (MnO₄⁻), silicate (SiO₄²⁻), borate (BO₃³⁻); organic anions such as acetate (C₂H₃O²⁻ or CH₃COO⁻), formate (CH₂O₂²⁻), oxalate (C₂O₄²⁻), citrate (C₆H₅O₇⁻³), thiocyanate (SCN⁻), perchlorate (ClO₄⁻), arsenate (AsO₄³⁻), arsenite (AsO₃³⁻); lanthanide ions such as lanthanum (La³⁺), cerium (Ce³⁺), praseodymium (Pr³⁺), neodymium (Nd³⁺), promethium (Pm³⁺), samarium (Sm³⁺), europium (Eu³⁺), gadolinium (Gd³⁺), terbium (Tb³⁺), dysprosium (Dy³⁺), holmium (Ho³⁺), erbium (Er³⁺), thulium (Tm³⁺), ytterbium (Yb³⁺), and lutetium (Lu³⁺).

The described method can achieve excellent removal efficiency with respect to the ions, including aqueous fluids having more than one or all these ions. The system has also been proven effective in efficiently collecting complex anions and has been successfully demonstrated using both surrogate solutions and contaminated pit lake and river water samples, as described in the Examples below. The magnetic particles used to remove these ions can comprise a naturally occurring magnetic material, magnetite (Fe₃O₄), a composite of magnetite, or a particle having a magnetic core, including in some embodiments, submicron sized particles. Similarly, a variety of magnet and magnet configurations can be used, including an electromagnet, a direct-current (DC) magnet, or a commutator, which can in some embodiments be present within a housing. Depending on the size of the application, the energized magnet can provide a magnetic field strength sufficient to efficiently capture magnetic particles having adsorbed ions.

The ions remove, including any of those described above, can be contaminant ions or any other ions, including those that are considered high-value ions. “High-value” ions include precious metals such as silver (Ag⁺), gold (Au³⁺), platinum (Pt²⁺), battery materials such as lithium (Li⁺) and cobalt (Co²⁺), industrial materials such as copper (Cu²⁺), nickel (Ni²⁺), and zinc (Zn²⁺), and other ions such as phosphate (PO₄³⁻) which can be of high value because they can be converted into products like battery-grade ferric phosphate (FePO₄).

The method can be performed in any suitable reactor system. In some aspects, at least the first four steps of the processing method are performed continuously along the length of a flow reactor. Other embodiments of the method can be performed as a batch, semi-batch, pipeline, plug flow method, or any combination of these methods. For example, one or more steps of the processing method can be performed in a stirred tank or continuous stirred tank.

With respect to embodiments of the reactor system, suitable reactor types (and vessels) include, but are not limited to, batch, semi-batch, pipeline, plug flow, stirred tank, continuous stirred tank, and continuous flow reactors. Magnets (or magnet modules) can incorporate an in-line magnetic field positioned within an optional housing, where the magnetic field can be energized and de-energized for particle capture and subsequent release into a separate stream. One embodiment of the system is distinguished from conventional batch ion exchange systems in that it offers continuous flow operation, enhanced efficiency, and versatility in using either synthetic ion exchange resins with magnetic cores or naturally occurring magnetically susceptible materials such as magnetite.

Furthermore, in some embodiments, multiple magnet modules can be arranged in series, concluding with a permanent magnet scavenger for example to maximize magnetic particle capture, and further allows for the parallel arrangement of multiple lines of magnets or modules thereof to accommodate higher volumetric aqueous stream flow rates. Additionally, a similar reactor and magnet module system can be used to strip and regenerate the magnetic particles, which allows for particle re-use in the system and recovery of metals from the strip solution.

A variety of magnetic particles can be used. In one embodiment, the magnetic particles comprise a naturally occurring magnetic material, magnetite (Fe₃O₄), a composite of magnetite, or a particle having a magnetic core. Treated water can be released back into the environment, minimizing negative environmental impacts. One concern is loss of the magnetic particles into the environment, especially contaminant-loaded particles, and Fe₃O₄ was selected as it is naturally occurring and would pose less of an environmental threat in the case of an accidental release compared to other synthetic magnetic particles. Loaded particles are of concern as they may become unstable and leach adsorbed ions back into the environment. Magnetic properties allow for simple and efficient collection by the CFMR system, reducing chemicals required for removal and production of secondary pollutants, and additional measures utilizing permanent magnets can be used to ensure minimal magnetic particle loss. The disclosed CFMR system represents a user-friendly, efficient, and effective method for ion removal and recovery from aqueous fluid (such as wastewaters).

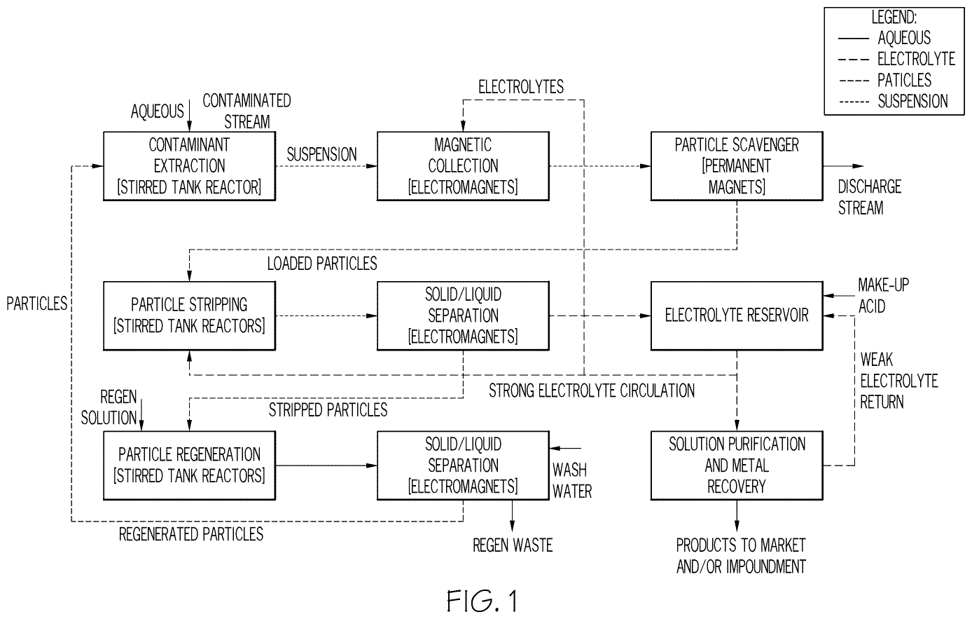

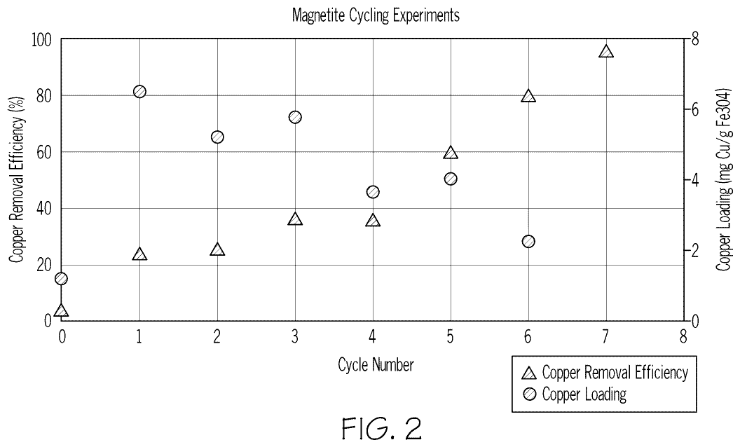

An exemplary embodiment of a reactor system for use with the disclosed method is shown in FIG. 1. The reactor system can include a mixing zone, where a slurry of magnetic particles (e.g., with magnetic cores or naturally occurring materials such as magnetite) can be mixed with an aqueous fluid such as a wastewater stream. The particle-laden mixture can be pumped through a reactor module or multiple reactor modules in series, where ions such as metal ions, complex anions, and cations present in the aqueous fluid bond, adsorb, or are otherwise attached to sites on the adsorbent particle surfaces. In a magnetic capture zone, a magnetic field can be positioned near the discharge end of the reactor to capture and retain the magnetic particles while allowing the liquid flow to continue unimpeded. In a magnetic particle release zone, periodically, the liquid flow can be diverted through a parallel magnet module, and the first magnetic field can be de-energized to release the magnetic particles. The particles can then advance to a separate circuit for ion removal via a desorption process. Optionally, the ions stripped from the particle surfaces can be concentrated in the strip solution. The strip solution can undergo material recovery via techniques such as cementation, precipitation, or electrowinning or further treatment in preparation for safe and responsible environmental disposal. Finally, the stripped particles can undergo chemical reconditioning and be reintroduced into service in the reactor. The process in some embodiments can be a continuous flow process particularly for larger scale industrial applications.

Embodiments of the reactor system exhibit several significant technical advancements over conventional batch ion exchange systems, including the following. Unlike batch systems, an embodiment of the reactor system allows for continuous operation, enabling higher throughput and more efficient removal of metal ions, complex anions, and other cations. The system is also capable of utilizing both synthetic ion exchange resins with magnetic cores and naturally occurring materials such as magnetite. This versatility demonstrates acceptable ion adsorption capabilities and provides flexibility in selecting the most suitable particles for specific applications. Embodiments of the system incorporate a straightforward design with no moving parts, relying on pumps and automatic valves for fluid control. In-line mixers can be used for example to create turbulence, ensuring efficient particle-fluid interaction. In one embodiment, an in-line magnetic particle capture module is employed, achieving a single-stage capture efficiency of over 98% for magnetite particles under optimal operating conditions. Multiple magnet modules can also be arranged in series within the reactor system to enhance particle capture efficiency. The series configuration can in one embodiment end with a permanent magnet scavenger to minimize the potential release of magnetic particles into the environment. The reactor system also allows for the arrangement of multiple lines of magnets in parallel to accommodate higher volumetric wastewater flow rates, enabling scalability and flexibility in large-scale applications.

### Examples

The following examples further illustrate this disclosure. The scope of the disclosure and claims is not limited by the scope of the following examples.

The following Example used a CFMR system in a series of experiments designed to evaluate its ability to effectively capture ion-loaded Fe₃O₄ particles from a feed stream. Magnetite adsorption on real water samples was also explored by treating water samples obtained from the Clark Fork River (CFR), which is of importance due to several factors, including high metals contamination from hard rock mining in the area, it forms the headwaters for the Columbia River system, and it is the largest river in Montana by volume. Experiments included flow-through and continuous CFMR operation, and single- and multi-stage adsorption. Models for CFMR operation were generated and validated using a central composite design with response surface methodology in DESIGN-EXPERT® 12, a logistic regression analysis software. The CFMR system was the focus of experimentation to demonstrate an efficient and effective water treatment process for real-world applications, specifically in ion-containing tributaries that feed into larger rivers and industrial applications. Results are shown in Tables 1-3.

TABLE 1
Single-Stage Adsorption for Surrogate Solutions

| Ion Type | Cᵢ (mg/L) | C_{f} (mg/L) | Removal Efficiency (%) |
|---|---|---|---|
| Cu²⁺ | 107.03 ± 0.39 | 0.10 ± 0.01 | 99.90 ± 0.01 |
| Pb²⁺ | 97.30 ± 3.45 | 0.11 ± 0.01 | 99.89 ± 0.00 |
| PO₄³⁻ | 100.80 | 0.83 | 99.17 |
| SeO₃²⁻ | 100.31 | 4.76 | 95.26 |
| Se⁴⁺ | 100.12 ± 0.07 | 2.52 ± 0.05 | 97.24 ± 0.19 |
| Gd³⁺ | 42.56 ± 1.01 | 0.014 ± 0.004 | 99.97 ± 0.01 |
| La³⁺ | 38.62 ± 1.07 | 0.003 ± 0.001 | 99.99 ± 0.00 |

TABLE 2
Multi-Stage Adsorption for Clark Fork River Samples

| Element | | | | | | |
|---|---|---|---|---|---|---|
| Experiment | Zn (μg/L) | As (μg/L) | Sr (μg/L) | Mo (μg/L) | Sb (μg/L) | Ba (μg/L) |
| MS - U | 8.71 ± 0.29 | 9.49 ± 0.12 | 263.61 ± 2.01 | 24.65 ± 0.12 | 0.49 ± 0.02 | 33.76 ± 0.26 |
| MS - 1 | 1.37 ± 0.09 | <0.2 | 58.19 ± 2.44 | <0.5 | <0.2 | <1 |
| MS - 2 | 1.55 ± 0.15 | <0.2 | 12.62 ± 1.43 | <0.5 | <0.2 | <1 |
| MS - 3 | 1.70 ± 0.23 | <0.2 | 3.66 ± 0.59 | <0.5 | <0.2 | <1 |
| MS - 4 | 1.17 ± 0.04 | <0.2 | 1.84 ± 0.37 | <0.5 | <0.2 | <1 |
| WQC | 37 | 150 | 20 | — | 0.5 | 3 |

TABLE 3
Magnetite Capture from Continuous Flow Experiments

| | Flow Rate | Fe₃O₄ Dose | Fe₃O₄ Recovered |
|---|---|---|---|
| Experiment Name | (Lpm) | (g) | (%) |
| CF - 1 and CF - 2 | 2.2 ± 0.2 | 280 | 37.87 |
| CF - 3 | 1.0 ± 0.2 | 200 | 80.44 |
| CF - 4 | | 200 | 84.36 |
| CF - 5 | 4.0 ± 0.2 | 170 | 93.16 |
| CF - 6 | | 170 | 75.98 |

### Materials and Equipment

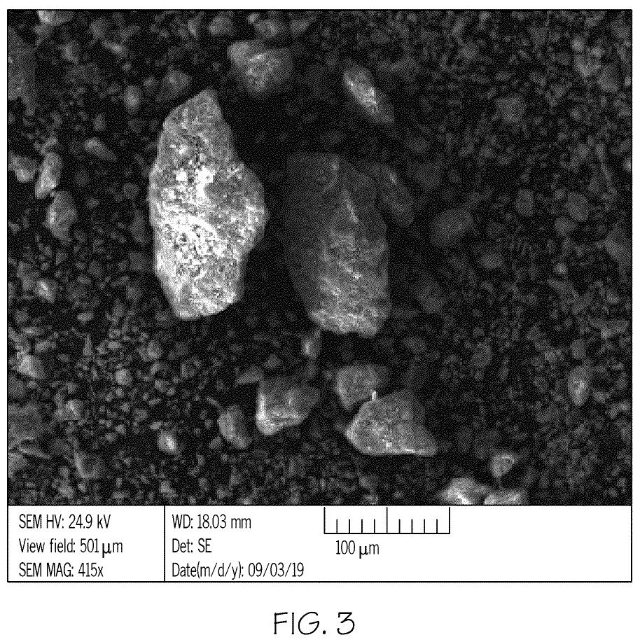

Experiments in this work used commercially available Fe₃O₄ purchased from U.S. Research Nanomaterials (Fe₃O₄, 98+%, 20-30 nm). A MIRA3 TESCAN scanning electron microscope (SEM) was used to obtain images of the sample, where a variety of morphologies are apparent, observed in FIG. 3.

Surrogate solutions (solutions prepared in the laboratory with known concentrations) were prepared with copper(II) sulfate pentahydrate (CuSO₄·5H₂O) purchased from Sigma Aldrich, and samples were analyzed with an iCAP 6500 Series inductively coupled plasma-optical emission spectrometer (ICP-OES). Water samples were collected from the Clark Fork River (CFR) at Arrow Stone Park in Deer Lodge, Montana and analyzed by the Montana Bureau of Mines and Geology using an iCAP Q inductively coupled plasma-mass spectrometer (ICP-MS) for trace metal analyses. All samples were preserved for analysis using nitric acid (HNO₃) for trace metals analysis from J.T. Baker.

The CFMR used included a magnetic collection module containing an electromagnet, which was chosen for the design to separate ion-loaded Fe₃O₄ from the feed due to ease of separation compared to use of permanent magnets. A Sartorius Corporation Practum 224-1S Balance (max 220 g) or Denver Instrument APX-1502 Analytical Balance (max 1500 g) were used to weigh Fe₃O₄ and CusO₄·5H₂O.

### Methods

### A. CFMR Experiments

i. Flow-Through Experiments

Flow-through experiments were conducted to determine optimal operating conditions for the CFMR. Operating parameters include breakthrough time (defined as time when particles were first observed in the effluent stream), flow rate, and Fe₃O₄ dose. Breakthrough was chosen as a parameter for experiments because any accidental release of ion-loaded Fe₃O₄ could cause environmental problems due to the potential for leaching; knowledge of the breakthrough time is important to prevent the electromagnet (EM) from becoming saturated and to establish electromagnet cycles when multiple magnetic collection modules are used. It was determined that the EM used in the experiments must produce at least 1 kG of electromotive force to achieve sufficient magnetite capture, therefore EM strength was not examined as a parameter for these experiments.

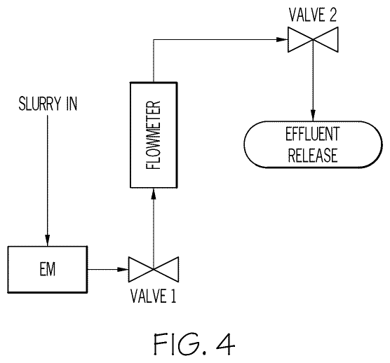

DESIGN-EXPERT® 12 was used to develop a statistical design of experiments using a central composite design with response surface methodology to identify optimal conditions for CFMR operation and minimize Fe₃O₄ loss (defined as amount of Fe₃O₄ entering the effluent stream). A series of 13 experiments, supplemented by two confirmation experiments, were conducted to determine the effects of flow rate and Fe₃O₄ dose on CFMR operation in flow-through mode, and the setup is shown in FIG. 4. Flow and dose were varied from 1.0 to 3.4 Lpm and 6 to 20 g Fe₃O₄/L, respectively. Understanding the effects of and interactions between these parameters on Fe₃O₄ capture in the CFMR can identify ideal operating conditions and enable improved design and scale-up of the CFMR system.

Flow-through experiments were performed under central composite design conditions for a duration of 5 min, and the procedure is as follows. Slurries were prepared by mixing Fe₃O₄ and deionized water (DI), agitating until completely dispersed. The EM was then energized, and the slurry was poured into the CFMR through the funnel. Simultaneously, the valve at the end of the system, valve 2 in FIG. 4, was opened and flow was adjusted using valve 1 in FIG. 4. As each experiment progressed, the time at which Fe₃O₄ was first seen in the end bucket, indicating Fe₃O₄ breakthrough, was recorded. After 5 min, indicating the end of each experiment, the flow was stopped, EM de-energized, and breakthrough Fe₃O₄ was collected from the end bucket. Breakthrough Fe₃O₄ was magnetically separated from the water, dried in air, and weighed to assess EM operation under varying magnetite concentrations and flow rates. The CFMR was flushed with DI between experiments until water from the valves ran clean. All experiments were conducted at room temperature and ambient pressure.

ii. Continuous Operation Experiments

Continuous operation experiments examined the effects of Fe₃O₄ dose, flow rate, and Cu(II) concentration and assessed the system's ability to perform for an extended period. Dose, flow rate, and Cu (II) concentration were varied from 140 to 200 g Fe₃O₄/L, 1 to 4 Lpm, and 100 to 500 mg Cu/L, respectively. Copper(II) was chosen as the ion for these studies as it is the most prominent ion in the surrounding region of Montana. Duplicates of 3 experiments were conducted on a setup that includes a mechanical mixer, feed tank, pump apparatus, electromagnet, power supply, tubing to recycle the water, and tubing to flush the electromagnet with deionized water. Continuous operation of the CFMR relies on utilizing a parallel or series configuration of multiple replicate magnetic collection modules, so demonstration of only a single collection module is necessary. In commercial embodiments, the CFMR system would be comprised of multiple electromagnets in a parallel and/or a series configuration.

The procedure for continuous experiments is as follows. Solutions were prepared by dissolving CuSO₄·5H₂O in DI and pouring the solution into the feed tank. Magnetite was added to the tank, and the slurry mixed at 800±10 rpm for 5 min prior to beginning the experiment to start Cu(II) adsorption onto Fe₃O₄. The pump was then turned on, flow adjusted, and EM energized. At 20 min intervals, flow was stopped to flush the EM, which was de-energized to release captured Fe₃O₄, with DI. Twenty-minute intervals were chosen due to the time required to flush the magnet (5-7 min) and lack of system automation. Flow was then restarted and EM reenergized. The Cu(II) solution was recycled through the CFMR over the 10 h period, and loss of solution or addition of DI from EM flushes were assumed to be negligible. Copper(II) solutions were cycled to accommodate limitations of the current CFMR setup, including size and use of only one magnetic collection module, and to minimize the volume of solution required for the experiments. Ion concentration and pH were recorded at specific sampling times over the course of 10 h. Magnetite captured by the EM over the 10 h was collected on a permanent magnet, air dried, and weighed to determine removal efficiency. For all experiments, all glassware and sample storage vials were triple rinsed with 5% HNO₃, then triple rinsed with 18 MΩ DI to minimize contamination. Between experiments, the CFMR tank was scrubbed, and the entire system was flushed with DI. All experiments were conducted at room temperature, intrinsic pH, and ambient pressure. All water samples were analyzed by ICP-OES.

### B. Single- and Multi-Stage Adsorption Experiments

Single- and multi-stage adsorption experiments were performed on water samples from the CFR to assess Fe₃O₄ adsorption capabilities in real water samples. The inventors established >95% removal of Cu(II), Pb(II), or PO₄³⁻ in surrogate solutions, therefore water samples containing many mixed elements were ideal for assessing viability of Fe₃O₄ for commercial applications. For all experiments, all glassware and sample storage vials were triple rinsed with 5% HNO₃, then triple rinsed with 18 MΩ DI to minimize potential contamination. Additionally, all experiments were conducted at intrinsic pH, room temperature, and ambient pressure. All samples were analyzed by an iCAP Q ICP-MS.

The procedure for single-stage removal is as follows. 500 mL of CFR water was measured into a 1 L beaker, and initial solution pH was recorded. The beaker was then placed under mechanical agitation at 400 rpm. Magnetite was weighed and added to the solution at approximately 20 g/L for all experiments. After 1 h of mixing, final pH was recorded and a sample taken. Samples were immediately filtered and preserved with HNO₃.

The procedure for multi-stage removal is the same as the procedure described in the previous paragraph with the addition of three subsequent stages, which are as follows. After 1 h of mixing, pH was measured and a 40 mL sample was taken, filtered, and preserved with HNO₃. A permanent magnet was then used to separate Fe₃O₄ from the depleted solution which was decanted into another 1 L beaker. The beaker was placed back under mechanical agitation at 400 rpm, and a fresh mass of Fe₃O₄ was added to the solution and mixed for another hour. The process was repeated for all stages with 1 h of mixing between stages.

### Results

### A. Flow-Through Experiments

A statistical design of experiments based on a central composite design was generated to optimize the flow of feed into the CFMR system in relation to Fe₃O₄ breakthrough and Fe₃O₄ loss. The design consisted of two numerical factors, flow and Fe₃O₄ dose, and two responses, Fe₃O₄ breakthrough and Fe₃O₄ loss to the treated stream. The results of the 13 experiments were input into the DESIGN-EXPERT® 12 experimental design for analysis by the software. An automatic model selection using Akaike's information criterion estimates the quality of each model compared to the other models and determines which terms to keep in the model. A reduced quadratic model with a base 10 log transform was chosen as the best model for the breakthrough data, while a reduced quadratic model with an inverse square root transform was chosen for the Fe₃O₄ model. Once the models have been generated, an analysis of variance (ANOVA) performs statistical tests, where p-values <0.05 of the model and <0.1 of the variables suggest significance. The obtained data indicated that the model and all factors are significant for the breakthrough model, and the Fe₃O₄ loss model indicates that the model, flow, and quadratic of Fe₃O₄ dose are significant, while Fe₃O₄ dose is not significant, but due to the quadratic being significant, Fe₃O₄ dose must be included in the model. Fit statistics, which aid in determining model quality, display positive results for both models. In both cases, agreement between R², adjusted R², and predicted R² suggests that the models fit the data and can interpolate points. Additionally, adequate precision, which assess signal-to-noise ratio, indicates strong signals for model optimization. Overall, ANOVA and fit statistics indicate the generated models are a good fit for the data.

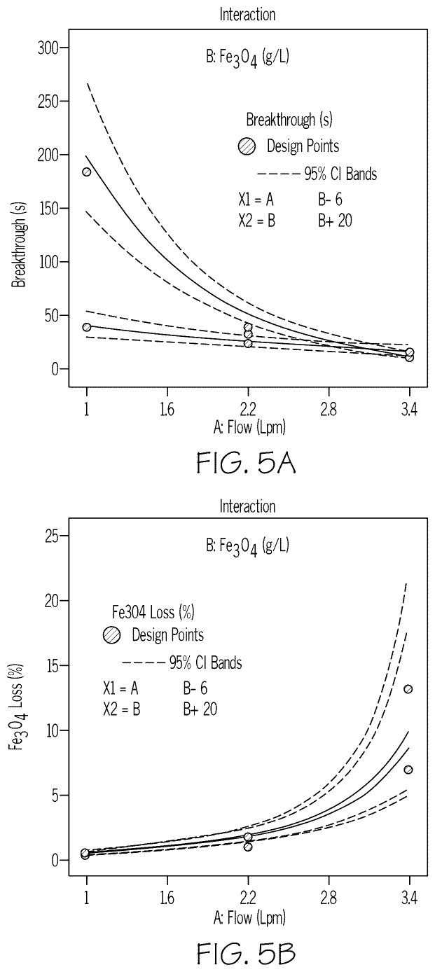

Further, diagnostics reveal additional information about trends, outliers, and influences on the model. One additional plot is the interaction plot, which aids in establishing behavior of the responses and numerical factors, presented in FIGS. 5A-5B. Referring to FIG. 5A, the breakthrough model reveals that flow rate does not have a significant impact on breakthrough time at high doses Fe₃O₄, while slower flows result in longer breakthrough times at low Fe₃O₄ doses. These results make sense because high Fe₃O₄ doses would saturate the EM more quickly, and high flows would result in faster breakthrough at low Fe₃O₄ doses. The Fe₃O₄ loss model (FIG. 5B) reveals that Fe₃O₄ dose does not have a significant effect on Fe₃O₄ loss, as the design points and 95% confidence interval bands lie near each other. These results indicate that the EM is not reaching saturation at the Fe₃O₄ doses used and higher doses would be needed to significantly affect Fe₃O₄ loss. The generated models establish optimal conditions of 1 Lpm to maximize Fe₃O₄ breakthrough time and near 2.8 Lpm to minimize Fe₃O₄ loss. The small-scale conditions under which these experiments were performed result in flows that are ideal for treating small streams and tributaries. Larger scale operations are also contemplated.

Additionally, two confirmation points were chosen from a list generated by DESIGN-EXPERT® 12 to evaluate the predictive capabilities of the model and statistically validate it. The first experiment was conducted using 6 g Fe₃O₄/L and 1.9 Lpm, and the second experiment used 20 g Fe₃O₄/L and 3.0 Lpm. Duplicate experiments were performed for each point and the confidence interval data was collected, where it can be observed that the data mean values are all within the 95% prediction intervals (PI).

### B. Continuous Operation Experiments

Continuous operation experiments were conducted to evaluate the CFMR system in terms of Fe₃O₄ capture and Cu(II) removal and assess performance over an extended period. Experiments were conducted using 10 L of Cu(II) solution, agitation speed of 800±10 rpm, Fe₃O₄ doses of 140 g/L for CF-1 and CF-2, 200 g/L for CF-3 and CF-4, and 170 g/L for CF-5 and CF-6, and initial copper concentrations of 100 mg/L for CF-1 and CF-2, 500 mg/L for CF-3 and CF-4, and 200 mg/L for CF-5 and CF-6. Experiments were performed at intrinsic pH, which ranged from 5.32 to 4.17, depending on CuSO₄·5H₂O concentration. The high- and mid-range Fe₃O₄ dose experiments at low and high flows, respectively, resulted in recoveries of 83% on average, whereas the low-range dose and mid-range flow experiments resulted in low recovery of 38%. Ideally, Fe₃O₄ recovery would approach 90+%, and potential causes for loss or low recoveries are Fe₃O₄ loss through the EM (indicating a stronger EM may be useful), caught in the system, or stuck within the EM coils. Another cause may be due to recycling the water, which increased in temperature to approximately 57° C. by the end of the experiments, potentially oxidizing Fe₃O₄ surfaces to hematite (Fe₂O₃) or converting a percentage to Fe₂O₃, which is non-magnetic. In practice, water would not be recycled and adding additional collection modules should alleviate heating problems.

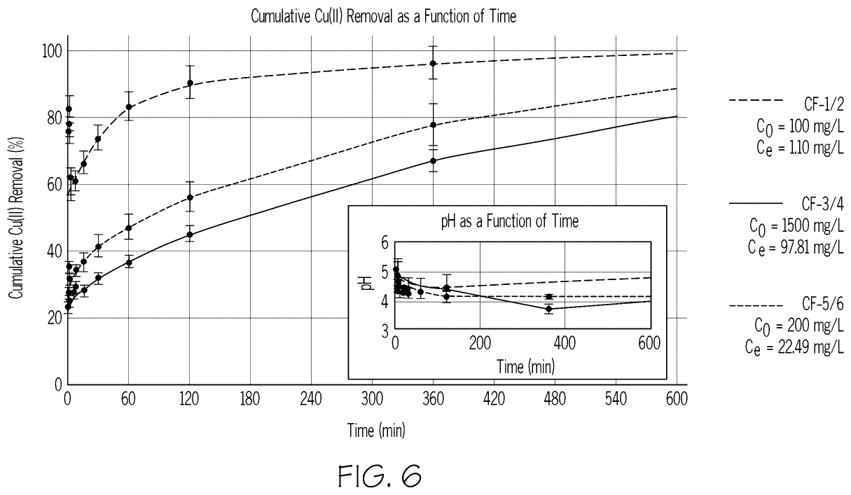

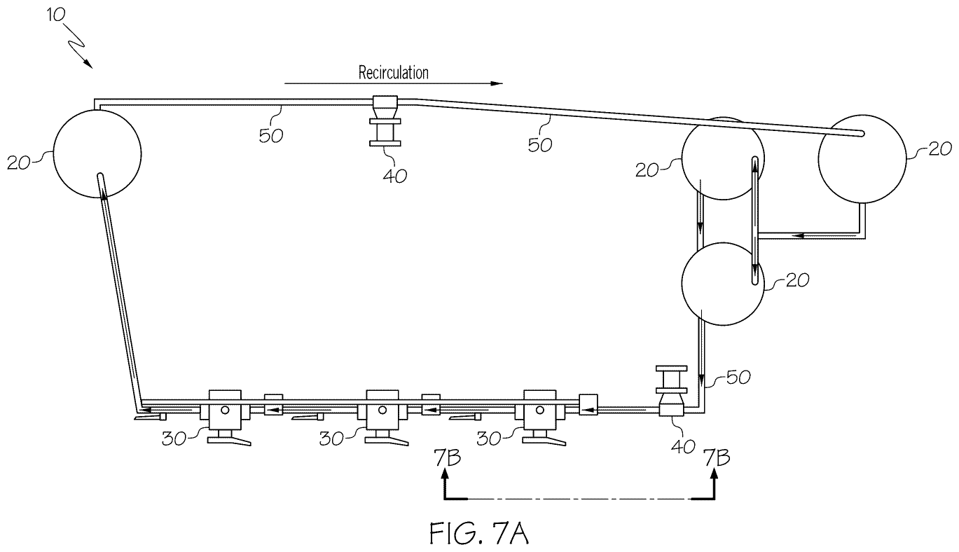

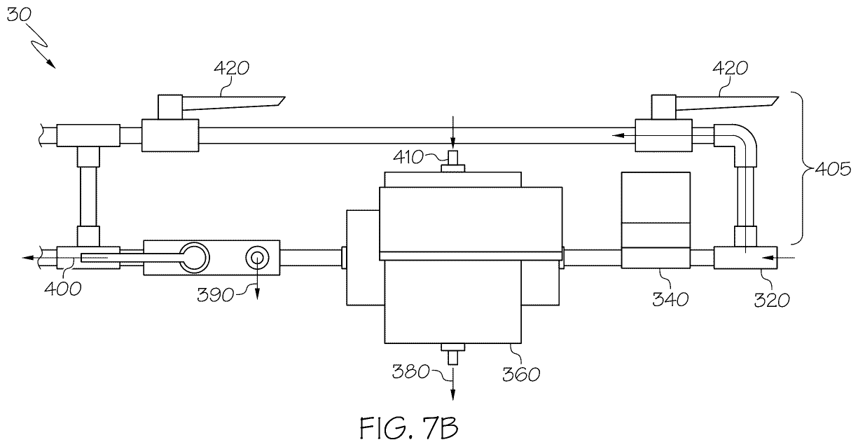

Further, Cu(II) removal was monitored over the course of the 10 h experiments. Results for duplicate experiments were averaged and data is presented FIG. 6, with error bars for percent removal representing a standard percent error based on slight drift of the continuous calibration verification samples from the ICP-OES. Copper(II) removal data (FIG. 6) reveals high removal efficiencies for all experiments. As expected, low Co resulted in the highest removal efficiency of 99%, while the highest Co achieved a removal efficiency of 80%. Some discrepancies are observed near the beginning of the experiments and are assumed to be caused by nonhomogeneous mixing, as some Cu(II) solution flowed into the pump system before starting, resulting in slightly fluctuating Cu(II) concentrations in the first several data points. Further, initial adsorption occurs rapidly for the lowest Cu(II) concentration, while it takes approximately 3 h for higher concentration experiments to achieve over 60% Cu(II) removal, and loading reached a maximum of 20 mg Cu(II)/g Fe₃O₄. These results indicate that increased Fe₃O₄ doses are useful to improve removal efficiencies, especially at high ion concentrations, and reduce Cu(II) concentrations below water quality criteria (WQC) of 2.85 μg/L at 25 mg/L hardness. Further, pH data is displayed as an insert to FIG. 6 and reveals an overall decrease in pH over the course of the experiments. Final concentrations were 4.77, 3.94, and 4.11 for experiments CF-1/2, CF-3/4, and CF-5/6, respectively.

### C. Magnetite Adsorption Experiments

Single-stage (SS) and multi-stage (MS) Fe₃O₄ adsorption experiments were conducted to evaluate Fe₃O₄ performance on real water samples containing a variety of ions. Trials labelled with a U represent untreated samples, representing the initial sample concentration, and trials labelled 1-4 represent the experimental stage number, where the final stage represents the final concentration. Triplicate experiments were performed on CFR water samples using 20 g Fe₃O₄/L, with averages and standard deviations presented above in Table 2. Water quality criteria, displayed in Table 2, were obtained from DEQ-7 and WHO guidelines and dashes indicate no value given.

Table 2 above presents excellent removal for selected ions. Initial concentrations for Zn, As, Sr, Sb, and Ba were already below WQC, but were reduced by Fe₃O₄ adsorption by approximately 85%, 98%, 78%, 60%, and 97%, respectively. Fe3O4 performance on CFR samples displays excellent results for application as the adsorbent media for use in the CFMR system.

In sum, a CFMR system was evaluated in flow-through and continuous operation to establish operating conditions and assess performance for an extended time. Statistical models for flow-through experiments indicated that flows around 1.0 Lpm are ideal to maximize Fe₃O₄ breakthrough time and under 2.8 Lpm to minimize Fe₃O₄ loss. Continuous experiments revealed Fe₃O₄ capture efficiencies between 37% and 93% and Cu(II) removal between 80% and 99%. Water samples from the CFR were treated with Fe₃O₄ to assess adsorption capabilities in natural waters and display excellent results, as many of the ions tested were removed to below water quality criteria or below instrument detection limits.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other compositions and methods for carrying out the several purposes of this disclosure. As a result, the claims should not be considered as limited by the description or examples.

### REFERENCES

E. Vunain, A. K. Mishra, and B. B. Mamba, “Dendrimers, mesoporous silicas and chitosan-based nanosorbents for the removal of heavy-metal ions: a review,” Int J Biol Macromol, vol. 86, pp. 570-586, 2016, doi: https://doi.org/10.1016/j.ijbiomac.2016.02.005.
P. B. Tchounwou, C. G. Yedjou, A. K. Patlolla, and D. J. Sutton, “Heavy Metal Toxicity and the Environment,” vol. 101, A. Luch, Ed., Springer, Basel, 2012, pp. 133-164. doi: 10.1007/978-3-7643-8340-4_6.
E. Ghasemi, A. Heydari, and M. Sillanpää, “Superparamagnetic Fe3O4@EDTA nanoparticles as an efficient adsorbent for simultaneous removal of Ag(I), Hg(II), Mn(II), Zn(II), Pb(II) and Cd(II) from water and soil environmental samples,” Microchemical Journal, vol. 131, pp. 51-56, 2017, doi: https://doi.org/10.1016/j.microc.2016.11.011.
J. M. Besser and K. J. Leib, “Toxicity of metals in water and sediment to aquatic biota,” in Integrated investigations of environmental effects of historical mining in the Animas River watershed, San Juan County, Colorado, S. E. Church, P. von Guerard, and S. E. Finger, Eds., U.S. Geological Survey, 2007, ch. E19, pp. 837-849. Accessed: Sep. 22, 2022. [Online]. Available: https://pubs.usgs.gov/pp/1651/downloads/Vol2_combinedChapters/vol2_chapE19.pdf
Z. Cheng, A. L. K. Tan, Y. Tao, D. Shan, K. E. Ting, and X. J. Yin, “Synthesis and characterization of iron oxide nanoparticles and applications in the removal of heavy metals from industrial wastewater,” International Journal of Photoenergy, vol. 2012, pp. 1-5, 2012, doi: 10.1155/2012/608298.
R. DeMars, “Health hazards from mining in Butte, Montana,” Teach the Earth. Accessed: Apr. 21, 2022. [Online]. Available: https://serc.carleton.edu/68792
M. Jaishankar, T. Tseten, N. Anbalagan, B. B. Mathew, and K. N. Beeregowda, “Toxicity, mechanism and health effects of some heavy metals,” Interdiscip Toxicol, vol. 7, no. 2, pp. 60-72, June 2014, doi: 10.2478/intox-2014-0009.
S. Ebrahimi and D. J. Roberts, “Sustainable nitrate-contaminated water treatment using multi cycle ion-exchange/bioregeneration of nitrate selective resin,” J Hazard Mater, vol. 262, pp. 539-544, November 2013, doi: 10.1016/j.jhazmat.2013.09.025.
D.-W. Cho, H. Song, B. Kim, F. W. Schwartz, and B.-H. Jeon, “Reduction of nitrate in groundwater by Fe(0)/magnetite nanoparticles entrapped in Ca-alginate beads,” Water Air Soil Pollut, vol. 226, no. 7, p. 206, July 2015, doi: 10.1007/s11270-015-2467-6.
T. Nur, M. A. H. Johir, P. Loganathan, T. Nguyen, S. Vigneswaran, and J. Kandasamy, “Phosphate removal from water using an iron oxide impregnated strong base anion exchange resin,” Journal of Industrial and Engineering Chemistry, vol. 20, no. 4, pp. 1301-1307, July 2014, doi: 10.1016/j.jiec.2013.07.009.
U.S. Environmental Protection Agency, “Nutrient indicators dataset,” U.S. Environmental Protection Agency. Accessed: Oct. 21, 2022. [Online]. Available: https://www.epa.gov/nutrient-policy-data/nutrient-indicators-dataset
Y.-S. Kim et al., “Simultaneous removal of phosphate and nitrate in wastewater using high-capacity anion-exchange resin,” Water Air Soil Pollut, vol. 223, no. 9, pp. 5959-5966, November 2012, doi: 10.1007/s11270-012-1331-1.
S. K. Sarker, N. Haque, M. Bhuiyan, W. Bruckard, and B. K. Pramanik, “Recovery of strategically important critical minerals from mine tailings,” J Environ Chem Eng, vol. 10, no. 3, 2022, doi: 10.1016/j.jece.2022.107622.
L. Echeverry-Vargas and L. M. Ocampo-Carmona, “Recovery of Rare Earth Elements from Mining Tailings: A Case Study for Generating Wealth from Waste,” Minerals, vol. 12, no. 8, p. 948, July 2022, doi: 10.3390/min12080948.
S. E. Can Sener et al., “Recovery of Critical Metals from Aqueous Sources,” ACS Sustain Chem Eng, vol. 9, no. 35, pp. 11616-11634, 2021, doi: 10.1021/acssuschemeng.1c03005.
P. Westerhoff et al., “Characterization, Recovery Opportunities, and Valuation of Metals in Municipal Sludges from U.S. Wastewater Treatment Plants Nationwide,” Environ Sci Technol, vol. 49, no. 16, pp. 9479-9488, August 2015, doi: 10.1021/es505329q.
E. Elbashier, A. Mussa, M. A. Hafiz, and A. H. Hawari, “Recovery of rare earth elements from waste streams using membrane processes: An overview,” Hydrometallurgy, vol. 204, p. 105706, September 2021, doi: 10.1016/J.HYDROMET.2021.105706.
K. Zglinicki, K. Szamalek, and S. Wolkowicz, “Critical Minerals from Post-Processing Tailing. A Case Study from Bangka Island, Indonesia,” Minerals, vol. 11, no. 4, p. 352, March 2021, doi: 10.3390/min11040352.
M. Sethurajan et al., “Recent advances on hydrometallurgical recovery of critical and precious elements from end of life electronic wastes—a review,” Crit Rev Environ Sci Technol, vol. 49, no. 3, pp. 212-275, 2019, doi: 10.1080/10643389.2018.1540760.
C. D. Powell et al., “Magnetic nanoparticle recovery device (MagNERD) enables application of iron oxide nanoparticles for water treatment,” Journal of Nanoparticle Research, vol. 22, no. 2, p. 48, February 2020, doi: 10.1007/s11051-020-4770-4.
B. Arnsten, “Designing an integrated wastewater-treatment system,” Chemical Engineering, vol. 127, no. 9, pp. 39-44, 2020, Accessed: Oct. 11, 2022. [Online]. Available: https://www.chemengonline.com/designing-integrated-wastewater-treatment-system/
S. Zhang et al., “Research progress, problems and prospects of mine water treatment technology and resource utilization in China,” Crit Rev Environ Sci Technol, vol. 50, no. 4, pp. 331-383, February 2020, doi: 10.1080/10643389.2019.1629798.
M. Mao, T. Yan, G. Chen, J. Zhang, L. Shi, and D. Zhang, “Selective capacitive removal of Pb 2+ from wastewater over redox-active electrodes,” Environ Sci Technol, vol. 55, no. 1, pp. 730-737, January 2021, doi: 10.1021/acs.est.0c06562.
M. Mao, T. Yan, J. Shen, J. Zhang, and D. Zhang, “Selective capacitive removal of heavy metal ions from wastewater over Lewis Base sites of S-Doped Fe—N—C cathodes via an electro-adsorption process,” Environ Sci Technol, vol. 55, no. 11, pp. 7665-7673, June 2021, doi: 10.1021/acs.est.1c01483.
F. Younas et al., “Current and emerging adsorbent technologies for wastewater treatment: trends, limitations, and environmental implications,” Water (Basel), vol. 13, no. 2, p. 215, January 2021, doi: 10.3390/w13020215.
S. Shibatani et al., “Study on magnetic separation device for scale removal from feed-water in thermal power plant,” IEEE Transactions on Applied Superconductivity, vol. 26, no. 4, pp. 1-4, June 2016, doi: 10.1109/TASC.2016.2523433.

What is claimed is:

1. A method of processing an aqueous fluid comprising ions, the method comprising
a) contacting the aqueous fluid with magnetic particles, thereby adsorbing ions to the magnetic particles;
b) after the contacting step, capturing the magnetic particles from the aqueous fluid with an energized magnet;
c) de-energizing the magnet, thereby releasing the magnetic particles; and
d) diverting the released magnetic particles away from the aqueous fluid, thereby removing ions from the fluid.

2. The method of claim 1, further comprising, after the diverting step, desorbing ions from the magnetic particles.

3. The method of claim 2, further comprising reconditioning the magnetic particles.

4. The method of claim 1, wherein the aqueous fluid is wastewater.

5. The method of claim 1, wherein the magnetic particles comprise a naturally occurring magnetic material, magnetite (Fe₃O₄), a composite of magnetite, or a particle having a magnetic core.

6. The method of claim 1, wherein the magnet is an electromagnet, a direct-current (DC) magnet, or a commutator.

7. The method of claim 1, which is a continuous-flow method wherein steps (a)-(d) are performed continuously along the length of a flow reactor.

8. The method of claim 1, which is a batch, semi-batch, pipeline, or plug flow method.

9. The method of claim 1, wherein one or more of steps (a)-(d) are performed in a stirred tank or continuous stirred tank.

10. A reactor system for processing an aqueous fluid comprising ions, comprising:
a) a fluid inlet for introducing the aqueous fluid;
b) at least one ion extraction zone configured to contact the aqueous fluid with magnetic particles, to thereby adsorb ions to the magnetic particles;
c) at least one magnetic collection zone configured to capture the magnetic particles having adsorbed ions using a magnetic field energized by a magnet;
d) at least one magnetic particle scavenging zone configured to release the magnetic particles from the magnet and divert the magnetic particles from the aqueous fluid, to thereby remove ions from the aqueous fluid;
e) optionally, a desorbing zone configured to desorb ions from the magnetic particles and divert them away from the magnetic particles;
f) optionally, a reconditioning zone configured to recondition the magnetic particles and re-introduce them into the aqueous fluid; and
g) a fluid outlet for directing processed aqueous fluid out of the reactor system.

11. The system of claim 10, wherein one or more zones are present along a continuous flow reactor, or present in a batch, semi-batch, pipeline, or plug flow reactor vessel.

12. The system of claim 10, wherein the magnet is an electromagnet, a direct-current (DC) magnet, or a commutator, optionally contained within a housing of the reactor system.

13. The system of claim 10, which comprises multiple magnetic collection zones arranged in a series.

14. The system of claim 10, which comprises multiple magnetic collection zones arranged in parallel.
